(19) United States
(12) Patent Application Publication
(10) Pub. No.: US 2025/0341938 A1
(43) Pub. Date: Nov. 6, 2025

(54) INTERACTION METHOD FOR LIGHT FIELD DISPLAY DEVICE, AND RELATED DEVICE

(71) Applicant: BOE Technology Group Co., Ltd., Beijing (CN)

(72) Inventors: Qingwen FAN, Beijing (CN); Lili CHEN, Beijing (CN); Jinghua MIAO, Beijing (CN); Xuefeng WANG, Beijing (CN)

(73) Assignee: BOE Technology Group Co., Ltd., Beijing (CN)

(21) Appl. No.: 18/869,010

(22) PCT Filed: May 12, 2023
(86) PCT No.: PCT/CN2023/094009

§ 371 Date: Nov. 25, 2024

(30) Foreign Application Priority Data
May 31, 2022 (CN) 202210629333.5

(51) Int. Cl. G06F 3/04815; G06F 3/04845; G06F 3/0486

(52) U.S. Cl. CPC G06F 3/04815; G06F 3/04845; G06F 3/0486

(57) ABSTRACT

The present disclosure provides an interaction method for a light field display device and related device. A display area of the light field display device includes an object display area and an operation panel area, the object display area includes a first object, and the operation panel area includes a first control and a second control corresponding to the first object and a second object respectively. In the method, display positions of the first control and the second control in the operation panel area are switched in response to a first swipe operation on the operation panel area, and display of the first object in the object display area is switched to display of the second object in response to the second control being at a target position in the operation panel area.

### CROSS-REFERENCE TO RELATED APPLICATIONS

The present application is a U.S. National Stage of International Application No. PCT/CN2023/094009 filed on May 12, 2023, which claims the benefit of priority to Chinese Application No. 202210629333.5 filed on May 31, 2022 and titled “INTERACTION METHOD FOR LIGHT FIELD DISPLAY DEVICE AND RELATED DEVICE”, the contents of each are incorporated herein by reference in their entireties for all purposes.

### TECHNICAL FIELD

The present disclosure relates to the field of light field display technology, and in particular to, an interaction method for a light field display device and a related device.

### BACKGROUND

In three-dimensional display, the display screen of an object is different at various angles. Therefore, the three-dimensional display may present a better display effect. In the light field display of related technology, the interaction for a light field display object (such as a light field 3D model) is single, which cannot meet the interaction needs of users.

### SUMMARY

The present disclosure provides an interaction method for a light field display device and a related device.

Embodiments of the present disclosure provide an interaction method for a light field display device, a display area of the light field display device includes an object display area and an operation panel area, the object display area includes a first object, and the operation panel area includes a first control and a second control corresponding to the first object and a second object respectively, and the method includes:
switching display positions of the first control and the second control in the operation panel area in response to a first swipe operation on the operation panel area: and
switching display of the first object in the object display area to display of the second object in response to the second control being at a target position in the operation panel area.

Embodiments of the present disclosure further provide an interaction device for a light field display device, including a display module, configured to:
switch display positions of a first control and a second control in an operation panel area in response to a first swipe operation on the operation panel area: and
switch display of a first object in an object display area to display of a second object in response to the second control being at a target position in the operation panel area.

Embodiments of the present disclosure further provide an electronic device, including a memory, a processor and a computer program stored in the memory and runnable on the processor, and the processor executes the program to implement the method described above.

Embodiments of the present disclosure further provide a non-transitory computer readable storage medium having computer instructions stored thereon, and the computer instructions are configured to cause a computer to implement the method described above.

Embodiments of the present disclosure further provide a computer program product including computer program instructions that, when run on a computer, cause a computer to perform the method described above.

### BRIEF DESCRIPTION OF THE DRAWINGS

In order to more clearly illustrate the technical solutions in the present disclosure or the related technology, the accompanying drawings to be used in the description of the embodiments or the related technology will be briefly introduced below. Obviously, the accompanying drawings in the following description are only embodiments of the present disclosure, and for a person skilled in the art, other accompanying drawings may be obtained based on these drawings without any creative labour.

FIG. 1 illustrates a schematic diagram of a hardware structure of a light field display device provided by an embodiment of the present disclosure:

FIG. 2A illustrates a schematic diagram of an operation panel area provided at a lower side of an object display area according to an embodiment of the present disclosure;

FIG. 2B illustrates a schematic diagram of an operation panel area provided at an upper side of an object display area according to an embodiment of the present disclosure:

FIG. 2C illustrates a schematic diagram of an operation panel area provided at a left side of an object display area according to an embodiment of the present disclosure;

FIG. 2D illustrates a schematic diagram of an operation panel area provided at a right side of an object display area according to an embodiment of the present disclosure:

FIG. 3 illustrates a schematic flow diagram of an method provided by an embodiment of the present disclosure:

FIG. 4A illustrates a schematic diagram of a light field display interface according to an embodiment of the present disclosure:

FIG. 4B illustrates a schematic diagram of a light field display interface according to an embodiment of the present disclosure:

FIG. 4C illustrates a schematic diagram of a light field display interface according to an embodiment of the present disclosure:

FIG. 4D illustrates a schematic diagram of a light field display interface according to an embodiment of the present disclosure:

FIG. 4E illustrates a schematic diagram of a light field display interface according to an embodiment of the present disclosure;

FIG. 4F illustrates a schematic diagram of a light field display interface according to an embodiment of the present disclosure;

FIG. 4G illustrates a schematic diagram of a light field display interface according to an embodiment of the present disclosure:

FIG. 4H illustrates a schematic diagram of a light field display interface according to an embodiment of the present disclosure:

FIG. 4I illustrates a schematic diagram of a light field display interface according to an embodiment of the present disclosure:

FIG. 5 illustrates a schematic structure diagram of an interaction device provided by an embodiment of the present disclosure; and

FIG. 6 illustrates a schematic workflow diagram of an interaction device provided by an embodiment of the present disclosure.

### DETAILED DESCRIPTION

In order to make the objectives, technical solutions and advantages of the present disclosure more clearly understood, the present disclosure is hereinafter described in further detail in connection with specific embodiments and with reference to the accompanying drawings.

It is to be noted that, unless otherwise defined, the technical terms or scientific terms used in the embodiments of the present disclosure shall have the ordinary meaning understood by a person skilled in the art to which the present disclosure belongs. The terms “first”, “second” and the like as used in the embodiments of the present disclosure do not indicate any order, number or importance, but are only used to distinguish different components. The words “include/including”, “comprise/comprising” and the like are intended to mean that the component or object before the word encompasses the component or object listed after the word and the equivalent thereof, and does not exclude other components or objects. Words such as “connect”, “couple” or the like are not limited to physical or mechanical connections, but may include electrical connections, whether direct or indirect. The words “up”, “down”, “left”, “right”, or the like are used only to indicate relative positional relationships. When the absolute position of the described object is changed, the relative position relationship may also be changed accordingly.

Research on light field technology is mainly divided into two major aspects, including light field acquisition and light field display. The light field acquisition technology is relatively mature, mainly to provide 3D digital content, the acquisition at one time may achieve promotion and use, and the acquisition does not require an individual consumer to complete, generally by a team to complete. Therefore, the market has a high acceptability to hardware cost, volume, power consumption of a light field acquisition system. In contrast, the light field display product is biased to the user side, and the individual user has a high requirement in terms of cost, volume, power consumption, comfort and other aspects. Currently, for a product with the light field display, a specific gesture operation may not be displayed in real time through the interaction between the user and a virtual three-dimensional object (e.g., a virtual three-dimensional light field model), and the light field display interface does not allow the user to obtain clear textual information, which makes the user have a poor experience and makes it difficult to satisfy the user's needs.

In view of the above, an embodiment of the present disclosure provides an interaction method for light field display which controls a display state of an object (e.g., a virtual three-dimensional object, etc.) based on a touch gesture event inputted by a user, thereby realizing interaction between the user and the virtual three-dimensional object, and displaying a control corresponding to the displayed object, etc., and thus enhancing the user experience.

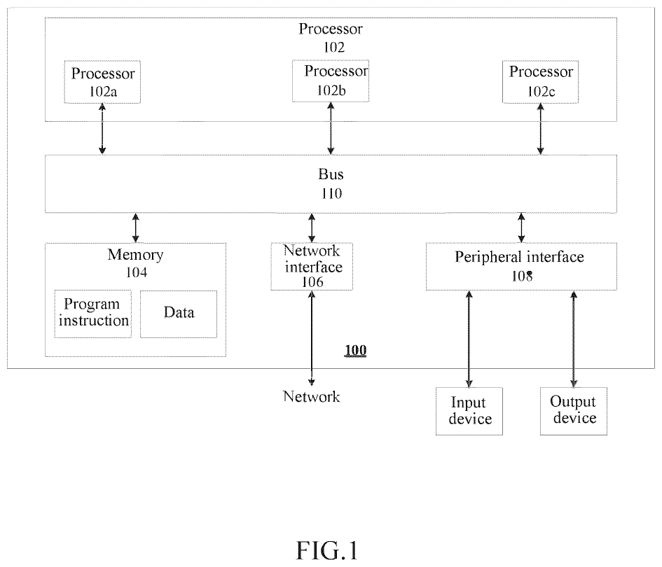

FIG. 1 illustrates a schematic diagram of a light field display device 100 provided by an embodiment of the present disclosure.

The light field display device 100 may be an electronic device. As shown in FIG. 1, the light field display device 100 may include a processor 102, a memory 104, a network interface 106, a peripheral interface 108, and a bus 110. The processor 102, the memory 104, the network interface 106, and the peripheral interface 108 are communicatively coupled to each other within the device via the bus 110.

The processor 102 may be a Central Processing Unit (CPU), an image processor, a neural network processor (NPU), a microcontroller (MCU), a programmable logic device, a digital signal processor (DSP), an Application Specific Integrated Circuit (ASIC), or one or more integrated circuits. The processor 102 may be used to perform a function related to the technique described in the present disclosure. In some embodiments, the processor 102 may also include a plurality of processors integrated into a single logic component. As shown in FIG. 1, the processor 102 may include a plurality of processors 102a, 102b, and 102c.

The bus 110 such as an internal bus (e.g., a processor-memory bus), an external bus (a USB port, a PCI-E bus), and the like, may be configured to transfer information between the various components (e.g., the processor 102, the memory 104, the network interface 106, and the peripheral interface 108) of the electronic device 100.

The memory 104 may be configured to store data (e.g., instructions, computer codes, etc.). As shown in FIG. 1, the data stored by the memory may include program instructions (e.g., program instructions for implementing a display method of the present disclosure) and to-be-processed data. The processor 102 may access program instructions and data stored in the memory and execute the program instructions to operate the to-be-processed data. The memory 104 may include a volatile storage device or a non-volatile storage device. In some embodiments, the memory 104 may include random access memory (RAM), read-only memory (ROM), optical discs, magnetic discs, hard drive, solid state drive (SSD), flash memory, memory stick, and the like.

The network interface 106 may be configured to provide the electronic device 100 with communication to other external devices via a network. The network may be any wired or wireless network capable of transmitting and receiving data. For example, the network may be a wired network, a local wireless network (e.g., Bluetooth, WiFi, Near Field Communication (NFC), etc.), a cellular network, the Internet, or a combination thereof. It is to be appreciated that the type of network is not limited to the specific examples described above. In some embodiments, the network interface 106 may include any number of network interface controllers (NICs), RF modules, receive transceivers, modems, routers, gateways, adapters, cellular network chips, and the like and any combination thereof.

The peripheral interface 108 may be configured to connect the electronic device 100 to one or more peripheral devices for information input and output. For example, the peripheral devices may include input devices such as keyboards, mice, touchpads, touchscreens, microphones, various types of sensors, and output devices such as displays, speakers, vibrators, indicator lights, and the like.

In some embodiments, the peripheral device may include a touch device such as a touch screen (e.g., a usb touch screen and a touchpad, etc.) or a touch pad (e.g., a gamepad, etc.) to achieve touch operation of the displayed object or the like. The peripheral device may also include a display device such as a liquid crystal display screen. The liquid crystal display screen mainly incudes a backlight module and a liquid crystal display panel. The liquid crystal display panel itself does not emit light, and relies on the light source provided by the backlight module to achieve brightness display. The liquid crystal display panel may be used in a passive display mode and may be applied to a high PPI display. The light field display device may be, for example, a thin and light near-eye display device such as Virtual Reality (VR), Augmented Reality (AR) and Mixed Reality (MR), a light field display, an in-vehicle display device or the like.

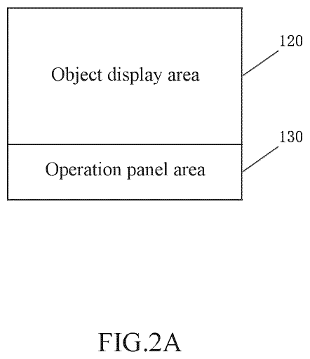

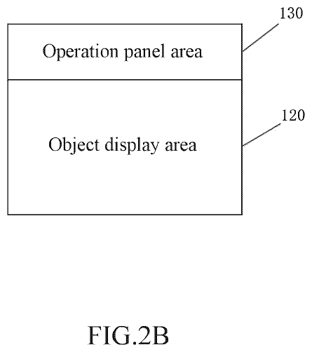

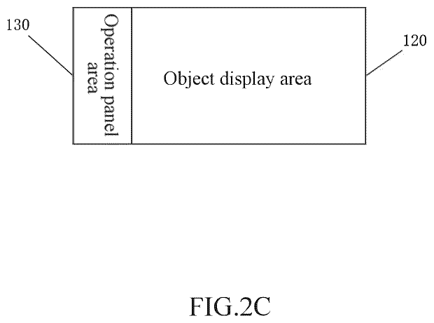

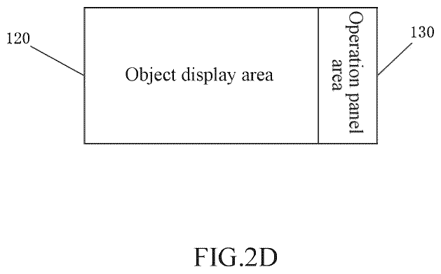

FIGS. 2A to 2D illustrate a schematic diagram of a display area of a light field display device provided by an embodiment of the present disclosure. FIG. 2A illustrates a schematic diagram in which an operation panel area 130 is provided at a lower side of an object display area 120: FIG. 2B illustrates a schematic diagram in which the operation panel area 130 is provided at an upper side of the object display area 120: FIG. 2C illustrates a schematic diagram in which the operation panel area 130 is provided at a left side of the object display area 120: and FIG. 2D illustrates a schematic diagram in which operation panel area 130 is provided at a right side of the object display 120.

In some embodiments, as shown in FIGS. 2A to 2D, a display area of the light field display device provided by an embodiment of the present disclosure may include two areas having different display effects, for example, may include the object display area 120 and the operation panel area 130. The object display area 120 is provided with a display module which has a structure such as a lens and can realize the light field display, i.e., the displayed object may be a virtual three-dimensional object. In contrast, the operation panel area 130 may not be provided with the display module which has the structure such as lens and can realize the light field display, and the operation panel area 130 may be provided with a display module which can realize an ordinary 2D display and thus can display a control (e.g., a control and a detail control, etc.) of a virtual 3D object.

In some embodiments, the operation panel area 130 may have different arrangement positions relative to the object display area 120, which may be specifically determined according to display requirements. For example, the operation panel area 130 may be provided at the lower side of the object display area 120 (e.g., FIG. 2A). The operation panel area 130 may also be provided at the upper side of the object display area 120 (e.g., FIG. 2B). The operation panel area 130 may also be provided at the left side of the object display area 120 (e.g., FIG. 2C). The operation panel area 130 may also be provided at the right side of the object display area 120 (e.g., FIG. 2D).

It is to be noted that although the above device architecture only illustrates the processor 102, the memory 104, the network interface 106, the peripheral interface 108, and the bus 110, in a specific implementation, the device architecture may also include other components necessary to achieve proper operation. In addition, it may be understood by a skilled in the art that the above-described device architecture may also include only the components necessary for realizing the embodiment solution of the present disclosure, and does not have to include all of the components shown in the drawings.

The following is an illustration of the interaction method for the light field display device according to an embodiment of the present disclosure by using an example that the operation panel area 130 is provided at the lower side of the object display area 120.

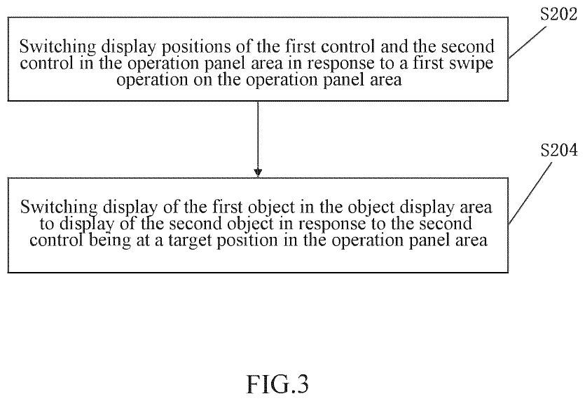

FIG. 3 illustrates a flow diagram of a method provided by an embodiment of the present disclosure. The method 200 may be implemented by the light field display device 100 of FIG. 1. Referring to FIG. 3, the method 200 may include the following steps.

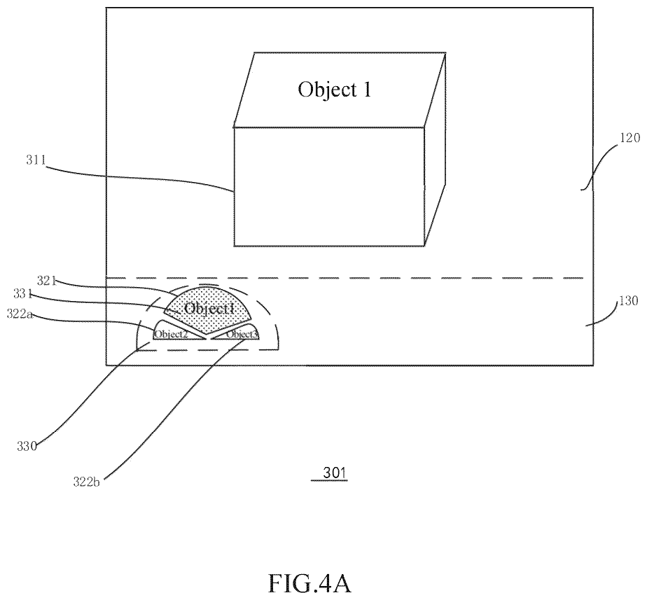

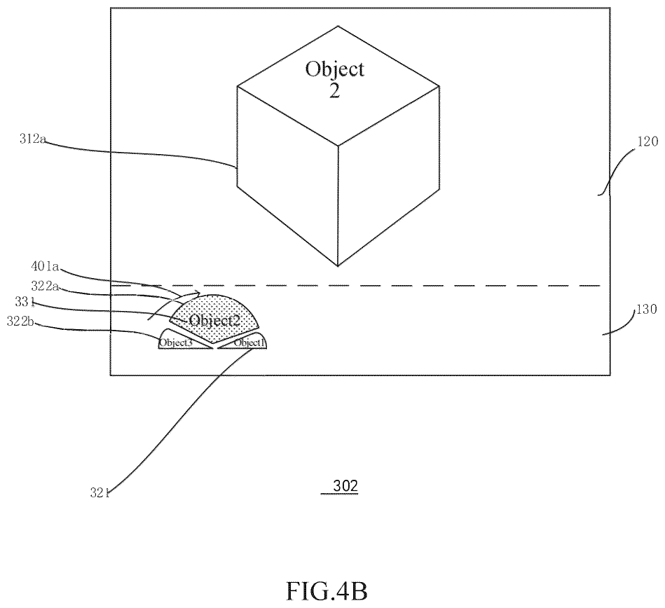

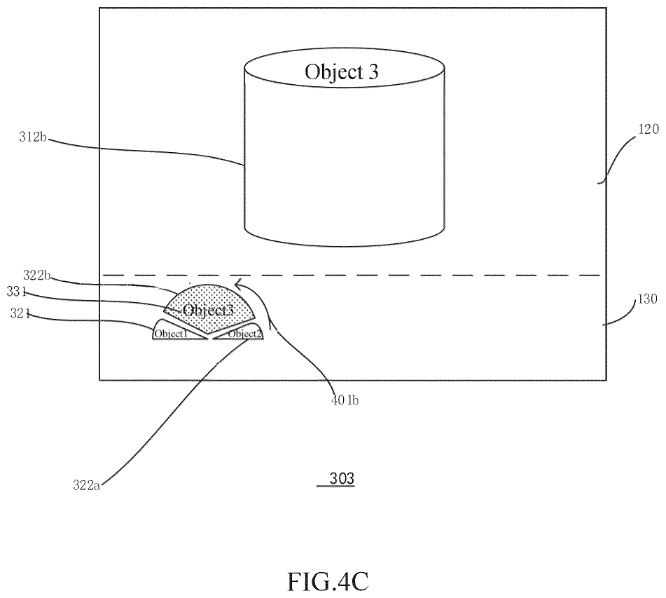

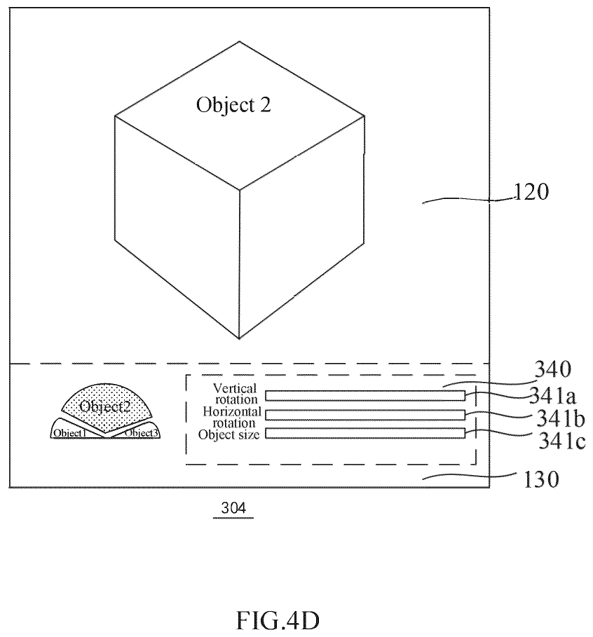

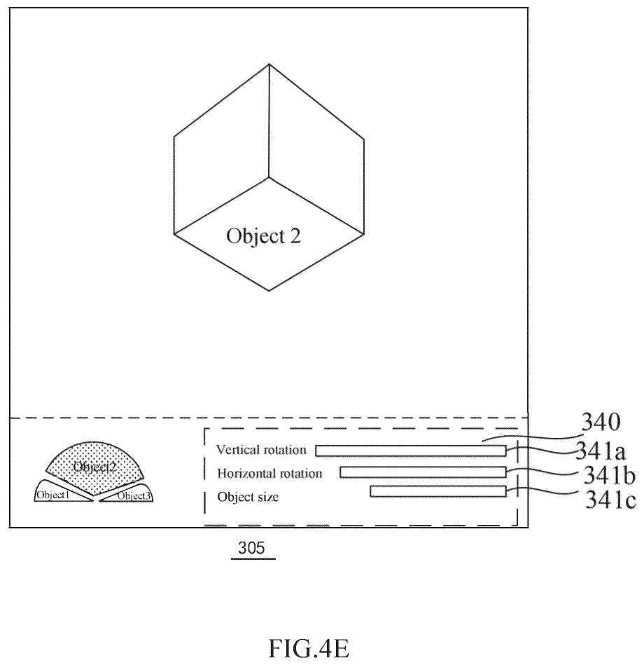

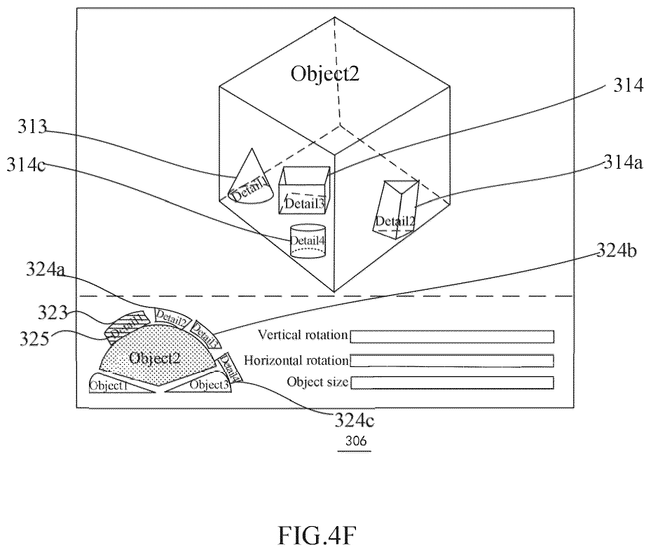

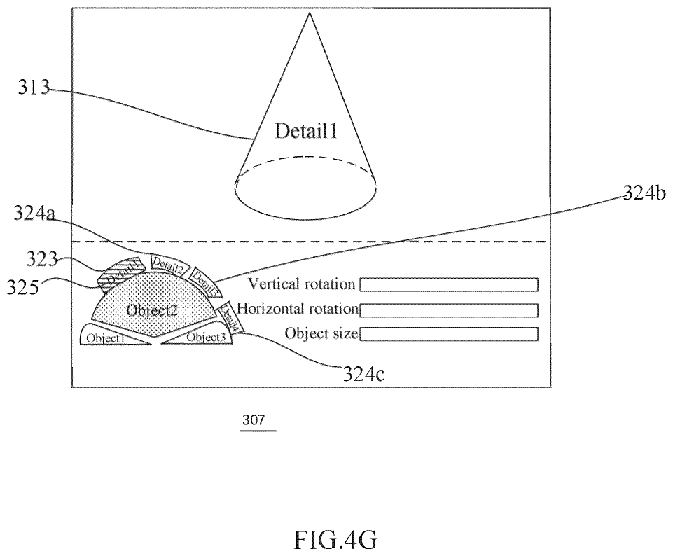

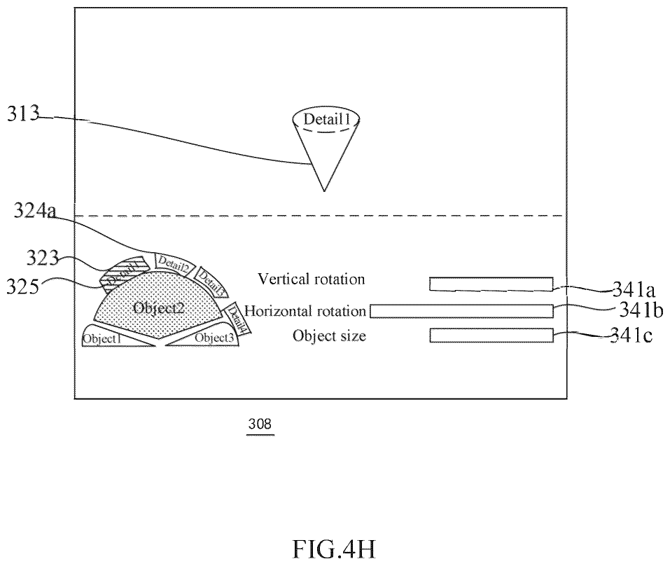

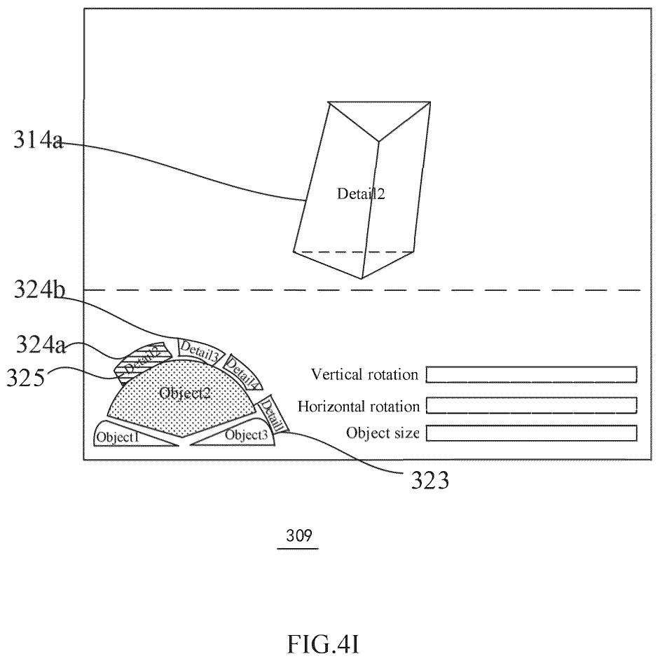

In an initial state, the light field display device may first display a first light field display interface 301. FIG. 4A illustrates a schematic diagram of a light field display interface according to an embodiment of the present disclosure. The manner in which the display device enters the first light field display interface 301 may be arbitrary. For example, the first light field display interface 301 is entered directly after the light field display device is powered on or through an application. In some embodiments, there may be a plurality of objects (e.g., object 1, object 2, and object 3, etc.) for the light field display in the object display area 120. After the device is powered on, the specific object displayed in the first light field display interface 301 may be an object (e.g., object 1) among the objects with the highest number of user votes (e.g., most selected by the user) determined based on a user questionnaire at the time of product design. Alternatively, it may be an object (e.g., object 1) that has the highest sum of the number of user votes determined based on a user questionnaire and the number of times it was viewed historically by the user. As shown in FIG. 4A, the first light field display interface 301 may be an interface that displays the first object 311 (e.g., object 1).

As shown in FIG. 4A, a plurality of controls respectively corresponding to the plurality of objects may be displayed in the operation panel area 130 of the first light field display interface 301. The control may be an object identifier, such as an object serial number or an object name. The object corresponding to the object identifier is the object itself. For example, the displayed controls may include a first control (e.g., control 321 for object 1) corresponding to a first object 311 (e.g., object 1), and a second control (e.g., control 322a for object 2 or control 322b for object 3) corresponding to a second object (e.g., object 2 or object 3). In some embodiments, the first control and the second control may both be located in a first operation area 330 and may be located at different positions in the first operation area 330. The control (e.g., control 321 for object 1) corresponding to the first object 311 (e.g., object 1) displayed in the object display area 120 may be located at a target position 331. In some embodiments, the first operation area 330 may be a pie-shaped area, and the target position 331 may be, for example, a position in the middle of the pie-shaped area. Therefore, a user may intuitively obtain the name of the object that is currently in the display state, etc., through the operation panel area 130.

In some embodiments, the control at the target position 331 may also be highlighted. This can facilitate a user to quickly identify the name of the object that is currently in the display state. The highlighting may include highlighting with a higher brightness or highlighting with an enlarged size, or the like. For example, as shown in FIG. 4A, the entire control 321 for object 1 is highlighted with a higher brightness.

Next, when the user intends to switch the first object in the object display area 120, the user may switch the control at the target position 331 by performing a trigger operation on the first operation area 330 of the operation panel area 130 by touching a peripheral device (e.g., a usb touch screen). The trigger operation may be, for example, a swipe operation of an arc gesture and a swipe operation of a pull-up gesture.

FIGS. 4B to 4C illustrate schematic diagrams of second light field display interfaces 302 and 303 obtained by switching after the first swipe operation is performed on the operation panel area 130 according to an embodiment of the present disclosure.

In step S202, display positions of the first control and the second control in the operation panel area 130 are switched in response to a first swipe operation on the operation panel area 130. Specifically, a swipe operation in a corresponding direction may be performed based on a relative position between the second control (e.g., control 322a for object 2 or control 322b for object 3) and the first control (e.g., control 321 for object 1). After switching, that is, the second control (e.g., control 322a for object 2 or control 322b for object 3) may be at the position of the first control (e.g., control 321 for object 1) (i.e., even if the second control is at the target position 331).

In some embodiments, the first swipe operation may be an arc gesture swipe operation. The swipe operation may be from the left side of the target position 331 towards the middle (e.g., the middle position 325) of the target position 331 in the pie-shaped area of the operation panel, i.e., a left-to-right swipe operation. For example, the first swipe operation may also be a swipe operation from the right side towards the middle in the pie-shaped area, i.e., a right-to-left swipe operation. For example, as shown in FIG. 4B, the first swipe operation may be a left-to-right swipe operation so that the second control (e.g., control 322a for object 2) may be switched to the target position 331 (e.g., a position in the middle of the pie-shaped area) in the pie-shaped area. Alternatively, for example, as shown in FIG. 4C, the first swipe operation may be a right-to-left swipe operation so that the second control (e.g., control 322b for object 3) may be switched to the target position 331 (e.g., the position in the middle of the pie-shaped area) in the pie-shaped area.

In step S204, display of the first object 311 (e.g., object 1) in the object display area 120 is switched to display of the second object 312a (e.g., object 2 or object 3) in response to the second control (e.g., control 322a for object 2 or control 322b for object 3) being at the target position 331 in the operation panel area 130. For example, as shown in FIG. 4B, the display of the first object 311 (e.g., object 1) is switched to the display of the second object 312a (e.g., object 2) in the object display area 120. Alternatively, for example, as shown in FIG. 4C, the display of the first object 311 (e.g., object 1) is switched to the display of the second object 312b (e.g., object 3) in the object display area 120. In this way, while viewing the first object 311 (i.e., the virtual 3D object), the user may control the display switching of the first object 311 and the second object (e.g., object 2 or object 3) by controlling the switching of the first control (e.g., control 321 for object 1) corresponding to the first object 311 and the second control (e.g., control 322a for object 2 or control 322b for object 3) corresponding to the second object (e.g., object 2 or object 3), and at the same time, the user can quickly locate the currently displayed object by displaying the second control (e.g., control 322a for object 2 or control 322b for object 3) at the target position 331, which has a highly efficient interaction efficiency, enriches the interaction manner, meets the diversified needs of users, and improves the user experience.

In some embodiments, in response to the second control being at the target position 331 in the operation panel area 130, the second control may be highlighted. For example, as shown in FIG. 4B, the second control (e.g., control 322a for object 2) is highlighted with a higher brightness so that the entire second control (e.g., control 322a for object 2) is in a highlighted state with a higher brightness to have a display color different from the first control (e.g., control 321 for object 1) and the other controls (e.g., control 322b for object 3). Alternatively, as shown in FIG. 4C, for example, the second control (e.g., control 322b for object 3) is highlighted with a higher brightness so that the entire second control (e.g., control 322b for object 3) is in a highlighted state with a higher brightness to have a display color different from the first control (e.g., control 321 for object 1) and the other controls (e.g., control 322a for object 2). In this way, it may facilitate a user to quickly identify the name or the like of the object which is currently in the display state.

FIG. 4D illustrates a schematic diagram of a third light field display interface according to an embodiment of the present disclosure.

In some embodiments, the control displayed in the operation panel area 130 may include not only the first control, but also a third control for adjusting the first object or the second object displayed in the object display area 120. For example, as shown in FIG. 4D, the operation panel area 130 may further include at least one third control for adjusting a display state (e.g., a different size and a different display angle) of the first object (e.g., object 1) or the second object (e.g., object 2 or object 3). The adjustment parameter corresponding to the third control may include at least one of a vertical angle, a horizontal angle, and an object size. The first object (e.g., object 1) or the second object (e.g., object 2 or object 3) has a display coefficient corresponding to the adjustment parameter of the third control. In some embodiments, for example, as shown in FIGS. 4A to 4C, when the first object (e.g., object 1) or the second object (e.g., object 2 or object 3) has the maximum display coefficient, it does not go beyond the object display area 120. In this way, incomplete display of the first object (e.g., object 1) or the second object (e.g., object 2 or object 3) after the adjustment is avoided, which improves the viewing experience of the user.

In some embodiments, the third control may include a plurality of kinds of third controls (e.g., three kinds), and the third control of each kind has a corresponding adjustment parameter (e.g., vertical angle, horizontal angle, or object size). For example, as shown in FIG. 4D, the third control may include a size control 341c for adjusting the object size of the first object (e.g., object 1) or the second object (e.g., object 2 or object 3), a vertical rotation control 341a for adjusting the vertical angle of the first object (e.g., object 1) or the second object (e.g., object 2 or object 3), a horizontal rotation control 341b for adjusting the horizontal angle of the first object (e.g., object 1) or the second object (e.g., object 2 or object 3) or the like. In this way, it may facilitate the user to better determine a refined display state corresponding to the first object (e.g., object 1) or the second object (e.g., object 2 or object 3), the first object (e.g., object 1) or the second object (e.g., object 2 or object 3) may be displayed better, and thus the user's experience is enhanced.

In some embodiments, the third control may have a plurality of presentation forms. For example, as shown in FIG. 4D, the third control may include a control name corresponding to the adjustment parameter and an adjustment bar corresponding to the adjustment parameter. For example, the size control 341c may include a size control name (object size) and an adjustment bar of a corresponding size parameter. The vertical rotation control 341a may include a control name (vertical rotation) and an adjustment bar of a corresponding vertical angle parameter. The horizontal rotation control 341b may include a control name (horizontal rotation) and an adjustment bar of a corresponding horizontal angle parameter. In this way, by setting the control name corresponding to the adjustment parameter and the adjustment bar corresponding to the adjustment parameter, the user may intuitively feel a changing process of a specific adjustment parameter.

It is to be understood that the specific sizes of the adjustment bars (e.g., the adjustment bar of the size control 341c, the adjustment bar of the vertical rotation control 341a, and the adjustment bar of the horizontal rotation control 341b) of the third controls correspond to specific sizes and/or angles of the objects (the first object or the second object) in the object display area, respectively. When the adjustment bar is dragged to the maximum size, the actual display size of the corresponding object (the first object or the second object) does not go beyond the object display area 120.

In some embodiments, for example, as shown in FIG. 4D, the operation panel area 130 may have a second operation area 340, and the third control may be provided in the second operation area 340. In this way, the user may better operate in different operation areas, and different operation controls may be conveniently displayed in a partitioning manner.

If a user wishes to view the first object (e.g., object 1) or the second object (e.g., object 2 or object 3) from different angles, or wishes to view the first object (e.g., object 1) or the second object (e.g., object 2 or object 3) of different sizes, the user may perform a trigger operation on the second operation area 340 of the operation panel area 130 by touching a peripheral device (e.g., a usb touch screen) to adjust the display state of the first object (e.g., object 1) or the second object (e.g., object 2 or object 3). The trigger operation may be, for example, a drag-and-drop operation or the like.

In some embodiments, the method may further include: adjusting, in response to a drag-and-drop operation directed to the third control, the first object or second object according to an adjustment parameter corresponding to the third control. For example, as shown in FIG. 4E, the drag-and-drop operation may be to simultaneously shorten the adjustment bar of the size control 341c, the adjustment bar of the vertical rotation control 341a, and the adjustment bar of the horizontal rotation control 341b. The size and angle of the second object (e.g., object 2) are adjusted according to the adjustment bar of the size control 341c, the adjustment bar of the vertical rotation control 341a and the adjustment bar of the horizontal rotation control 341b, and the second object (e.g., object 2) after the adjustment (e.g., becoming smaller and having a certain rotation angle) is displayed.

FIG. 4F illustrates a schematic diagram of a fourth light field display interface according to an embodiment of the present disclosure.

In some embodiments, for example, as shown in FIG. 4F, the object (e.g., object 2) displayed in the current object display area may have at least one detail, such as a first detail 313 (e.g., detail 1), a second detail 314a (e.g., detail 2), a second detail 314b (e.g., detail 3), or a second detail 314c (e.g., detail 4), and the like. Correspondingly, the control (e.g., second control) may have a first detail control 323 corresponding to the first detail 313 of the object (e.g., object 2), and a second detail control 324a, a second detail control 324b, or a second detail control 324c corresponding to the second detail or the like. It is to be appreciated that the object (e.g., object 1) that is not displayed in the current object display area may also have at least one detail, such as the first detail and the second detail. Correspondingly, the control (e.g., the first control) corresponding to the object (e.g., object 1) that is not displayed in the current object display area may have a first detail control corresponding to the first detail and a second detail control corresponding to the second detail, or the like.

If a user wishes to view the detail of the first object (e.g., object 1) or the second object (e.g., object 2 or object 3), the detail of the first object (e.g., object 1) or the second object (e.g., object 2 or object 3) may be displayed by performing a trigger operation on the first operation area 330 of the operation panel area 130 through touching a peripheral device (e.g., a usb touch screen). The trigger operation may be, for example, a swipe operation of a pull-up gesture or the like.

In some embodiments, the method may further include: displaying a first detail control and a second detail control corresponding to the first object or the second object in the operation panel area in response to a second swipe operation on the first control or the second control at the target position. For example, as shown in FIG. 4F, a first detail control 323 (e.g., control for detail 1) and a second detail control (e.g., control for detail 2, control for detail 3 and control for detail 4) corresponding to the second object (e.g., object 2) may be displayed in a drawer form above the second control by sliding upwardly at the second control (e.g., control for object 2) in the middle of the pie-shaped area.

In some embodiments, the method may further include: arranging the first detail control 323 and the second detail control 324a in a first direction according to an arrangement order of the first detail control 323 and the second detail control 324a. The arrangement order may be set according to viewing frequencies corresponding to the first detail control 323 and the second detail control 324a, e.g., from the highest viewing frequency to the lowest viewing frequency. The first direction may be a left-to-right direction, for example, as shown in FIG. 4F. In this case, the first detail control 323 (e.g., detail 1) and the second detail control (e.g., second detail control 324a, second detail control 324b, or third detail control 324c) having the arrangement order may be displayed in the left-to-right direction from a middle position 325 above the second control.

In some embodiments, the viewing frequency may be the number of user votes for the first detail and the second detail determined based on a user questionnaire at the time of product design. Alternatively, the viewing frequency may be the sum of the number of user votes for the first detail or the second detail determined based on a user questionnaire and the number of times the user historically viewed the first detail or the second detail.

In some embodiments, the method further includes: highlighting the first detail control 323 in response to determining that the first detail control 323 is arranged first.

Next, in response to that the second swipe operation directed to the first control or the second control at the target position is being performed, for example, the touch for the swipe operation still occurs on the screen, the first detail and second detail are displayed in the first object or the second object in the object display area. For example, as shown in FIG. 4F, a first detail 313 corresponding to the first detail control 323 and a second detail 314a corresponding to the second detail control 324a are displayed in the second object (e.g., object 2), thereby displaying a perspective view of the second object (e.g., object 2).

Next, in response to the end of the second swipe operation directed to the first control or the second control at the target position, for example, the touch for the swipe operation has left the screen, the first detail of the first object or the second object is displayed in the object display area. For example, in the object display area, the first detail 313 and the second details 314a ˜314c displayed in the second object in FIG. 4F are switched to that shown in FIG. 4G, i.e., only the first detail 313 (e.g., detail 1) corresponding to the first detail control 323 of the second object (e.g., object 2) is displayed.

If a user wishes to view the detail of the first object (e.g., object 1) or the second object (e.g., object 2 or object 3) from different angles, or wishes to view the detail of the first object (e.g., object 1) or the second object (e.g., object 2 or object 3) of different sizes, the user may perform a trigger operation on the second operation area 340 of the operation panel area 130 by touching a peripheral device (e.g., a usb touch screen) to adjust a display state of the detail of the first object (e.g., object 1) or the second object (e.g., object 2 or object 3). The trigger operation may be, for example, a drag-and-drop operation, or the like.

In some embodiments, the method further includes: adjusting, in response to a drag-and-drop operation directed to the third control, a first detail of the first object or the second object according to an adjustment parameter corresponding to the third control. For example, as shown in FIG. 4H, the drag-and-drop operation may be to shorten both the adjustment bar of the size control 341c and the adjustment bar of the vertical rotation control 341a. The size and display angle of the first detail 313 (e.g., detail 1) are adjusted according to the adjustment bar of the size control 341c and the adjustment bar of the vertical rotation control 341a, and the adjusted first detail 313 (e.g., detail 1) (e.g., becoming smaller and having a certain vertical rotation angle) is displayed.

If the user wishes to switch the first detail 313 in the object display area, the user may perform a trigger operation on the first operation area 330 of the operation panel area 130 by touching a peripheral device (e.g., a usb touch screen) to display the second detail of the first object (e.g., object 1) or the second object (e.g., object 2 or object 3). The trigger operation may be, for example, a swipe operation, or the like.

In some embodiments, the method further includes: highlighting the second detail control in response to a third swipe operation on the operation panel area: and displaying a second detail of the first object or the second object in the object display area. As shown in FIG. 4I, the third swipe operation may be a right-to-left swipe operation above the pie-shaped area in FIG. 4H, so that in the pie-shaped area (e.g., above the second control), the second detail control 324a (e.g., control for detail 2) may be switched to be at the middle position 325 above the second control, and the display of the first detail 313 (e.g., detail 1 in FIG. 4H) of the second object (e.g., object 2) in the object display area is switched to the display of the second detail 314a (e.g., detail 2 in FIG. 4I) of the second object (e.g., object 2).

Next, when the user wishes to switch the second detail 314a back to the first detail 313, the third swipe operation may be a left-to-right swipe operation. For example, the first detail control 323 (e.g., shown in FIG. 4I) may be switched back to the middle position 325 above the second control (e.g., shown in FIG. 4H) by sliding the first detail control 323 (e.g., shown in FIG. 4I) from right to left in the pie-shaped operation area (e.g., above the second control) in FIG. 4I, and in the object display area, the display of the second detail 314a (e.g., detail 2 in FIG. 4I) of the second object (e.g., object 2) is switched to the display of the first detail 313 (e.g., detail 1 in FIG. 4H) of the second object (e.g., object 2).

If the user wishes to switch the detail of the first object or the second object in the object display area to be the first object or the second object, the user may hide the first detail control and the second detail control in the operation panel area by performing a trigger operation on the first operation area in the operation panel area through touching a peripheral device (e.g., a usb touch screen). The trigger operation may be, for example, a fourth swipe operation, or the like.

In some embodiments, the method further includes: hiding the first detail control and the second detail control in the operation panel area in response to a fourth swipe operation on the operation panel area. For example, an arc gesture operation of swiping down (i.e., pulling down) may be performed on the detail control above the second control (e.g., control for object 2) at the middle position 325 in FIG. 4I to hide the first detail control 323 and all the second detail controls corresponding to the second object (e.g., object 2) displayed above the second control, and the display of the detail 2 is switched to the display of the object 2 in the object display area (e.g., as shown in FIG. 4E).

It is to be noted that the method of the embodiments of the present disclosure may be performed by a single device, for example, a computer or a server and the like. The method of the embodiments of the present disclosure may also be applied in a distributed scenario and be performed by a plurality of devices in cooperation with each other. In the case of such a distributed scenario, one of these devices may execute only one or more steps of the method of the embodiments of the present disclosure, and these devices may interact with each other to complete the described method.

It is to be noted that some embodiments of the present disclosure are described above. Other embodiments are within the scope of the appended claims. In some cases, the actions or steps recited in the claims may be performed in a different order from that in the embodiments described above and may still achieve the desired results. Further, the processes depicted in the accompanying drawings do not necessarily require the particular order or sequential order shown to achieve the desired results. In some embodiments, multitasking and parallel processing is also possible or may be advantageous.

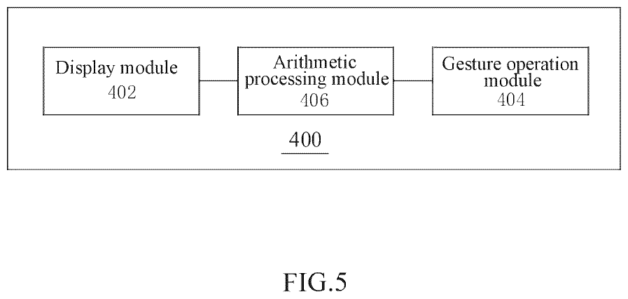

Based on the same inventive concept and corresponding to any of the above embodiment methods, the present disclosure also provides an interaction device for a light field display device. FIG. 5 illustrates a schematic structure diagram of a device 400 provided by an embodiment of the present disclosure.

Referring to FIG. 5, the interaction device 400 may include a display module 402, configured to:
switch display positions of a first control and a second control in an operation panel area in response to a first swipe operation on the operation panel area: and
switch display of a first object in an object display area to display of a second object in response to the second control being at a target position in the operation panel area.

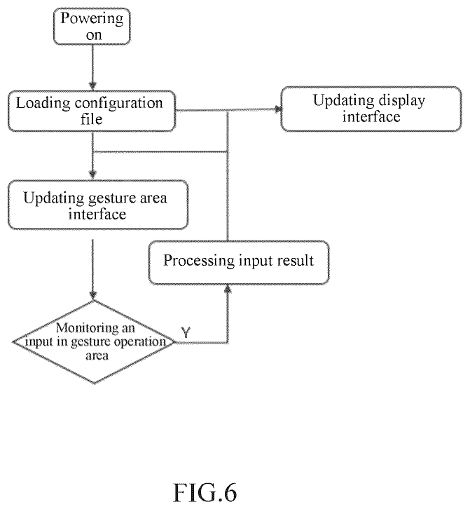

It is to be understood that the interaction device of the embodiments of the present disclosure may further include a gesture operation module 404 and an arithmetic processing module 406. A specific workflow diagram thereof may be shown in FIG. 6. The gesture operation module 404 is mainly used to obtain the user's gesture information as a system input, and record the user's gesture information and feed it back to the arithmetic processing module. Specifically, a starting position of a user's click may be detected on a peripheral devices such as touch screen (for example, a usb touch screen and touchpad, etc.) or a touch pad (for example, a gamepad, etc.) and other touch devices, the light field display device electronic device (Android sdk) is introduced to provide a GestureDetector interface, and the user's input gesture is identified through the interface, for example, different gestures may be identified through the on TouchEvent (event) method.

The arithmetic processing module 406 is mainly used to receive the user's gesture information transmitted by the gesture operation module 404, including a gesture category and a gesture start position, etc., and control the interface display content of the display module 402 by processing such information. For example, a correspondence of object interaction relationships in the gesture recognition result system on the touchpad is performed to control the object, the processing result is returned to the display module, and the display module correspondingly switches the display object according to the processing result, and so on. At the same time, the arithmetic processing module also updates the control arrangement direction (i.e., the UI layout) in the operation panel area according to the processing result of the gesture recognition, and returns the processing result to the display module, and the display module performs the corresponding display switching in the operation panel area according to the processing result.

In some embodiments, the display module 402 is further configured to: highlight the second control in response to the second control being at the target position in the operation panel area.

In some embodiments, the operation panel area includes a first operation area, the first control and the second control are located in the first operation area, and the first swipe operation is a swipe operation directed to the first operation area. The operation panel area includes a second operation area, and the second operation area includes at least one third control configured to adjust the first object or the second object displayed in the object display area. The display module 402 is further configured to: adjust, in response to a drag-and-drop operation directed to the third control, the first object or the second object according to an adjustment parameter corresponding to the third control.

In some embodiments, the adjustment parameter includes at least one of a vertical angle, a horizontal angle, or an object size. The display module 402 is further configured to: display a first detail control and a second detail control corresponding to the first object or the second object in the operation panel area in response to a second swipe operation on the first control or the second control at the target position.

In some embodiments, when displaying the first detail control and the second detail control corresponding to the first object or the second object in the operation panel area, the display module 402 is further configured to:
arrange the first detail control and the second detail control in a first direction according to an arrangement order of the first detail control and the second detail control.

In some embodiments, the display module 402 is further configured to: set the arrangement order according to viewing frequencies corresponding to the first detail control and the second detail control.

In some embodiments, the display module 402 is further configured to:
highlight the first detail control in response to determining that the first detail control is arranged first: and
display a first detail of the first object or the second object in the object display area.

In some embodiments, the display module 402 is further configured to:
highlight the second detail control in response to a third swipe operation on the operation panel area: and
display a second detail of the first object or the second object in the object display area.

In some embodiments, the display module 402 is further configured to: hide the first detail control and the second detail control in the operation panel area in response to a fourth swipe operation on the operation panel area.

For convenience of description, the above device is described in terms of functions divided into various modules described separately. Of course, the functions of the various modules may be implemented in the same one or more software and/or hardware when implementing the present disclosure.

The device of the above embodiments is used to implement the corresponding interaction method 200 for the light field display device in any of the foregoing embodiments and has the beneficial effects of the corresponding method embodiments, which will not be repeated herein.

Based on the same inventive concept and corresponding to the method in any of the foregoing embodiments, the present disclosure also provides a non-transitory computer-readable storage medium having computer instructions stored thereon, and the computer instructions are used to cause the computer to execute the interaction method 200 for the light field display device as described in any of the foregoing embodiments.

In an embodiment, the computer-readable media includes permanent and non-permanent, removable and non-removable media, which may be used by any method or technique to implement information storage. The information may be computer-readable instructions, data structures, program modules or other data. Examples of storage media for computer include, but are not limited to, phase-change memory (PRAM), static random-access memory (SRAM), dynamic random-access memory (DRAM), other types of random-access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cartridge tape, magnetic tape magnetic disk storage or other magnetic storage device or any other non-transmission medium that can be used to store information that can be accessed by a computing device.

The storage medium of the above embodiments stores computer instructions for causing the computer to execute the interaction method 200 for the light field display device as described in any of the above embodiments and has the beneficial effects of the corresponding method embodiments, which will not be repeated herein.

Based on the same inventive concept and corresponding to any of the above method embodiments, the present disclosure also provides a computer program product that, when runs on a computer, causes the computer to execute the interaction method 200 for the light field display device as described in any of the foregoing embodiments.

It is to be understood by a person skilled in the art that the discussion of any of the above embodiments is merely exemplary and is not intended to imply that the scope of the present disclosure (including the claims) is limited to these examples: under the concept of the present disclosure, the features in above embodiments or different embodiments may be combined, the steps thereof may be implemented in any order, and there are many other variations in different aspects of the embodiments of the present disclosure described above, details of which are not provided for the sake of brevity.

Further, to simplify the description and discussion and not to make the embodiments of the present disclosure difficult to understand, well-known power/ground connections to integrated circuit (IC) chips and other components may or may not be shown in the accompanying drawings provided. In addition, the device may be shown in a block diagram form in order to avoid making the embodiments of the present disclosure difficult to understand, and this also takes into account the following fact, i.e., the details regarding the manner in which these block diagram devices are to be implemented are highly dependent on the platform on which the embodiments of the present disclosure are to be implemented (i.e., these details should be well within the understanding of a person skilled in the art). In the case where specific details (e.g., a circuit) are set forth to describe embodiments of the present disclosure, it will be apparent to a person skilled in the art that the embodiments of the present disclosure can be implemented without these specific details or with variations of these specific details. Accordingly, these descriptions should be considered illustrative and not limiting.

Although the present disclosure has been described in connection with specific embodiments of the present disclosure, many substitutions, modifications, and variations of these embodiments will be apparent to a person skilled in the art in light of the preceding description. For example, other memory architectures (e.g., dynamic RAM (DRAM)) may use the discussed embodiments.

The embodiments of the present disclosure are intended to cover all such substitutions, modifications, and variations that fall within the broad scope of the appended claims. Accordingly, any omissions, modifications, equivalent substitutions, improvements, and the like made within the spirit and principle of the embodiments of the present disclosure shall be included within the protection scope of the present disclosure.

1. An interaction method for a light field display device, wherein a display area of the light field display device comprises an object display area and an operation panel area, the object display area comprises a first object, and the operation panel area comprises a first control and a second control corresponding to the first object and a second object respectively, and the method comprises:
switching display positions of the first control and the second control in the operation panel area in response to a first swipe operation on the operation panel area; and
switching display of the first object in the object display area to display of the second object in response to the second control being at a target position in the operation panel area.

2. The method according to claim 1, further comprising:
highlighting the second control in response to the second control being at the target position in the operation panel area.

3. The method according to claim 1, wherein the operation panel area comprises a first operation area, the first control and the second control are located in the first operation area, and the first swipe operation is a swipe operation directed to the first operation area.

4. The method according to claim 3, wherein the operation panel area comprises a second operation area, the second operation area comprises at least one third control configured to adjust the first object or the second object displayed in the object display area, and the method further comprises:
adjusting, in response to a drag-and-drop operation directed to the third control, the first object or the second object according to an adjustment parameter corresponding to the third control.

5. The method according to claim 4, wherein the adjustment parameter comprises at least one of a vertical angle, a horizontal angle, or an object size.

6. The method according to claim 1, further comprising:
displaying a first detail control and a second detail control corresponding to the first object or the second object in the operation panel area in response to a second swipe operation on the first control or the second control at the target position.

7. The method according to claim 6, wherein displaying the first detail control and the second detail control corresponding to the first object or the second object in the operation panel area comprises:
arranging the first detail control and the second detail control in a first direction according to an arrangement order of the first detail control and the second detail control.

8. The method according to claim 7, further comprising:
setting the arrangement order according to viewing frequencies corresponding to the first detail control and the second detail control.

9. The method according to claim 7, further comprising:
highlighting the first detail control in response to determining that the first detail control is arranged first; and
displaying a first detail of the first object or the second object in the object display area.

10. The method according to claim 9, further comprising:
highlighting the second detail control in response to a third swipe operation on the operation panel area; and
displaying a second detail of the first object or the second object in the object display area.

11. The method according to claim 6, further comprising:
hiding the first detail control and the second detail control in the operation panel area in response to a fourth swipe operation on the operation panel area.

12. (canceled)

13. A light field display device, comprising a memory, a processor and a computer program stored in the memory and runnable on the processor,
wherein a display area of the light field display device comprises an object display area and an operation panel area, the object display area comprises a first object, and the operation panel area comprises a first control and a second control corresponding to the first object and a second object respectively,
wherein the computer program, when being executed by the processor, causes the light field display device to implement actions comprising:
switching display positions of the first control and the second control in the operation panel area in response to a first swipe operation on the operation panel area; and
switching display of the first object in the object display area to display of the second object in response to the second control being at a target position in the operation panel area.

14.-15. (canceled)

16. The light field display device according to claim 13, wherein the actions further comprise:
highlighting the second control in response to the second control being at the target position in the operation panel area.

17. The light field display device according to claim 13, wherein the operation panel area comprises a first operation area, the first control and the second control are located in the first operation area, and the first swipe operation is a swipe operation directed to the first operation area.

18. The light field display device according to claim 17, wherein the operation panel area comprises a second operation area, the second operation area comprises at least one third control configured to adjust the first object or the second object displayed in the object display area, and the actions further comprise:
adjusting, in response to a drag-and-drop operation directed to the third control, the first object or the second object according to an adjustment parameter corresponding to the third control.

19. The light field display device according to claim 18, wherein the adjustment parameter comprises at least one of a vertical angle, a horizontal angle, or an object size.

20. The light field display device according to claim 13, wherein the actions further comprise:
displaying a first detail control and a second detail control corresponding to the first object or the second object in the operation panel area in response to a second swipe operation on the first control or the second control at the target position.

21. The light field display device according to claim 20, wherein displaying the first detail control and the second detail control corresponding to the first object or the second object in the operation panel area comprises:
arranging the first detail control and the second detail control in a first direction according to an arrangement order of the first detail control and the second detail control.

22. The light field display device according to claim 21, wherein the actions further comprise:
setting the arrangement order according to viewing frequencies corresponding to the first detail control and the second detail control.

23. The light field display device according to claim 21, wherein the actions further comprise:
highlighting the first detail control in response to determining that the first detail control is arranged first; and
displaying a first detail of the first object or the second object in the object display area.
